(19) United States
(12) Patent Application Publication
(10) Pub. No.: US 2014/0086123 A1
(43) Pub. Date: Mar. 27, 2014

(54) DISABLING A LOW POWER MODE TO IMPROVE THE RECEPTION OF HIGH PRIORITY MESSAGES

(71) Applicant: Apple Inc., Cupertino, CA (US)

(72) Inventors: Giri Prassad Deivasigamani, San Jose, CA (US); Gaurav Nukala, Santa Clara, CA (US)

(73) Assignee: Apple Inc., Cupertino, CA (US)

(21) Appl. No.: 14/020,553

(22) Filed: Sep. 6, 2013

Related U.S. Application Data
(60) Provisional application No. 61/706,355, filed on Sep. 27, 2012.

(51) Int. Cl. H04W 52/02

(52) U.S. Cl. CPC H04W 52/0225
USPC 370/311

(57) ABSTRACT

Embodiments of a wireless user equipment device are disclosed that may allow for the detection of radio frequency conditions. The device may be configured to determine message priorities and control the activation of a connected mode discontinuous reception in response to the message priorities.

### PRIORITY CLAIM

This application claims benefit of priority of U.S. Provisional Patent Application Ser. No. 61/706,355, filed on Sep. 27, 2012, which is incorporated by reference herein in its entirety.

### FIELD

This disclosure relates to wireless devices, and more particularly to improved operation of wireless devices while in a discontinuous reception mode.

### DESCRIPTION OF THE RELATED ART

Wireless communication systems are rapidly growing in usage. Further, wireless communication technology has evolved from voice-only communications to also include the transmission of data, such as Internet and multimedia content.

In order to reduce power consumption and improve the battery life of wireless user equipment (UE), discontinuous reception (DRX) has been introduced in several wireless standards such as UMTS, LTE (Long-term evolution), WiMAX, etc. DRX mode powers down most of the UE circuitry when there are no packets to be received or transmitted and only wakes up at specified times or intervals to listen to the network. DRX can be enabled in different network connection states, including connection mode and idle mode. In connected mode DRX (C-DRX), the UE listens to the downlink (DL) packets following a specified pattern determined by the base-station (BS). In idle DRX (IDRX) mode, the UE listens to the page from the BS to determine if it needs to reenter the network and acquire the uplink (UL) timing.

C-DRX was introduced by 3GPP standards in order to keep more UEs in a connected state with good battery savings. The UE and the network (NW) enter in to the C-DRX depending on data inactivity (e.g., based on the last time a packet was sent/received). However this does not take into account the radio conditions and the resulting RF propagation delay and processing delay, etc. One important thing to note here is that there is no explicit signaling between UE and NW on when to enter/exit C-DRX mode at the time of occurrence.

A possible scenario where the UE may be penalized by staying in C-DRX is when a high priority message (e.g., a measurement report to trigger a handover (HO)) is sent to the NW and the round trip time (RTT) for this packet is greater than the C-DRX entry interval. In such cases the UE will go in to a C-DRX mode (will not listen on DL for a finite time). This in-turn results in a delay in getting a Handover command from NW. Sometimes, this can also lead to a call drop if the cell is degrading fast. Also, this scenario of RTT being greater than the C-DRX entry interval is very likely to occur for handover scenarios since the HO thresholds are configured so that measurement reports are triggered at poor radio frequency (RF) conditions on the serving cell.

Therefore, improvements are desired in wireless communication systems.

### SUMMARY OF THE EMBODIMENTS

Various embodiments of a wireless user equipment device are disclosed. Broadly speaking, a device and method are contemplated in which a device may detect radio frequency conditions, determine the priority of a transmitted message in response to the detection of the radio frequency conditions, and in response to the priority of the transmitted message, activate a low power mode.

In one embodiment, the user equipment device may measure the response time of the transmitted message, and activate the low power mode in response to the measured response time. The user equipment device may also perform a comparison between the measured response time and a pre-determined delay.

In a non-limiting embodiment, the method may include the detection of radio frequency conditions by determining the number of radio link failures. The method may include activating a low power mode in response to the number of radio link failures. In some embodiments, the low power mode may be a connected mode discontinuous reception.

### BRIEF DESCRIPTION OF THE DRAWINGS

A better understanding of the present invention can be obtained when the following detailed description of the embodiments is considered in conjunction with the following drawings.

FIG. 1 illustrates an embodiment of a wireless communication system.

FIG. 2 illustrates an embodiment of a base station.

FIG. 3 illustrates a block diagram of a user equipment device.

FIG. 4 illustrates a block diagram of a base station.

FIG. 5 illustrates a flowchart diagram depicting a method for operating a user equipment device.

FIG. 6 illustrates a flowchart of a method for operating a user equipment device.

FIG. 7 depicts a flowchart of a method for operating a user equipment device.

FIG. 8 illustrates an embodiment of a method for operating a user equipment device.

FIG. 9 illustrates a flowchart diagram of a method for operating a user equipment device.

FIG. 10 illustrates a method for operating a user equipment device.

FIG. 11 illustrates a flowchart depicting an embodiment of a method for operating a user equipment device.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component. More generally, the recitation of any element is expressly intended not to invoke 35 U.S.C. §112, paragraph six interpretation for that element unless the language “means for” or “step for” is specifically recited.

### DETAILED DESCRIPTION OF THE EMBODIMENTS

### Acronyms

The following acronyms are used in the present patent application:

LTE: Long Term Evolution

UMTS: Universal Mobile Telecommunication System

GSM: Global System for Mobile communications

C-DRX: Connected mode Disconnected Reception

UL: Uplink

DL: Downlink

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer over a network, such as the Internet. In the latter instance, the second computer system may provide program instructions to the first computer system for execution. The term “memory medium” may include two or more memory mediums which may reside in different locations, e.g., in different computer systems that are connected over a network.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station (BS)—The term “Base Station” has the full breadth of its ordinary meaning, and at least includes a wireless communication station installed at a fixed location and used to communicate as part of a wireless telephone system or radio system.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

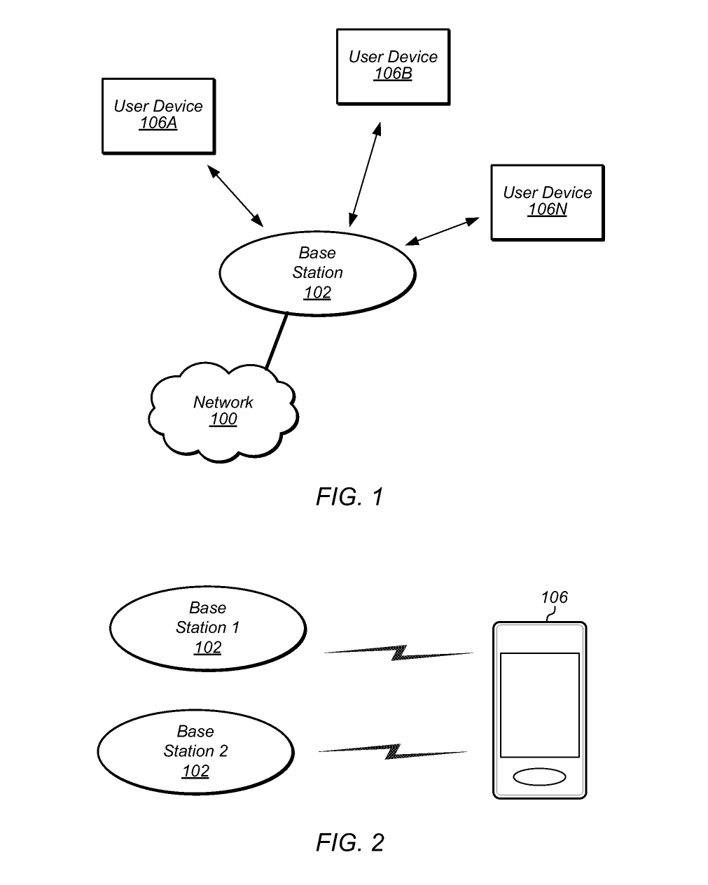

FIG. 1 illustrates an embodiment of a wireless communication system. It is noted that the system of FIG. 1 is merely one example of a possible system, and embodiments of the disclosure may be implemented in any of various systems, as desired.

The illustrated embodiment includes a base station 102 which communicates over a transmission medium with one or more User Equipment (UE) (or “UE devices”) 106A through 106N.

The base station 102 may be a base transceiver station (BTS) or cell site, and may include hardware that enables wireless communication with the UEs 106A through 106N. The base station 102 may also be equipped to communicate with a network 100. Thus, the base station 102 may facilitate communication between the UEs and/or between the UEs and the network 100. The communication area (or coverage area) of the base station may be referred to as a “cell.” The base station 102 and the UEs may be configured to communicate over the transmission medium using any of various wireless communication technologies such as LTE, UMTS, GSM, CDMA, WLL, WAN, WiFi, WiMAX, etc.

FIG. 2 illustrates UE 106 (e.g., one of the devices 106A through 106N) in communication with the base station 102. The UE 106 may be a device with wireless network connectivity such as a mobile phone, a hand-held device, a computer or a tablet, or virtually any type of wireless device. The UE 106 may include a processor that is configured to execute program instructions stored in memory. The UE may perform any of the embodiments described herein by executing such stored instructions. In some embodiments, the UE may include a programmable hardware element such as an FPGA (field-programmable gate array) that is configured to perform any of the method embodiments described herein, or any portion of any of the method embodiments described herein.

In some embodiments, the UE 106 may be configured to recover uplink synchronization with the network 100 after a timing alignment failure, for example as further described subsequently herein.

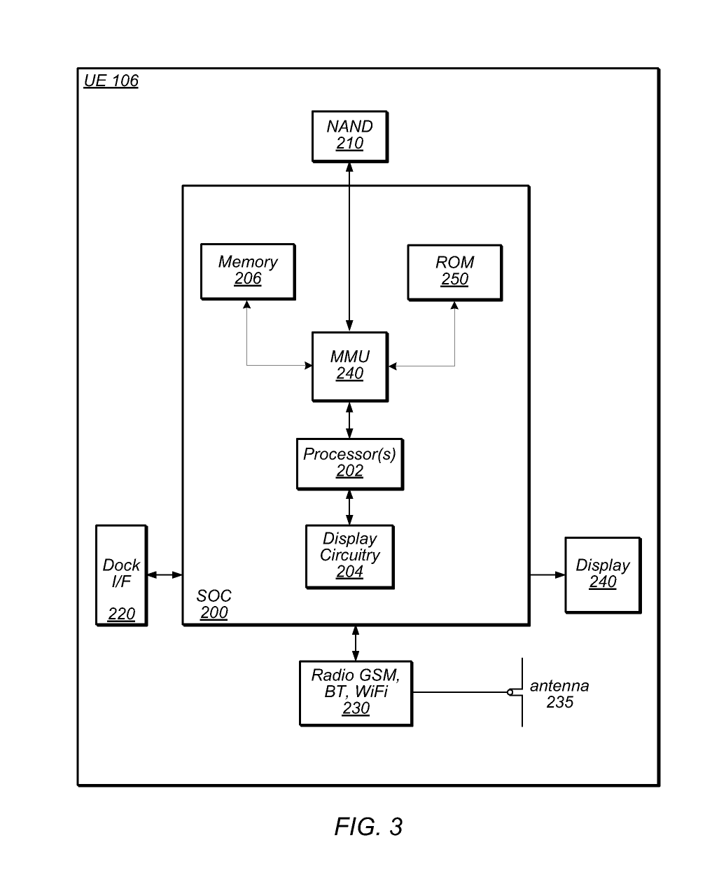

FIG. 3 illustrates a block diagram of an embodiment of user equipment. As shown, the UE 106 may include a system on chip (SOC) 200, which may include portions for various purposes. For example, as shown, the SOC 200 may include processor(s) 202 which may execute program instructions for the UE 106 and display circuitry 204 which may perform graphics processing and provide display signals to the display 240. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, radio 230, connector I/F 220, and/or display 240. The MMU 240 may be configured to perform memory protection and page table translation or set up. In some embodiments, the MMU 240 may be included as a portion of the processor(s) 202.

As also shown, the SOC 200 may be coupled to various other circuits of the UE 106. For example, the UE 106 may include various types of memory (e.g., including NAND flash 210), a connector interface 220 (e.g., for coupling to the computer system), the display 240, and wireless communication circuitry 230 (e.g., for LTE, Bluetooth, WiFi, etc.) which may use antenna 235 to perform the wireless communication. Some or all of the hardware and/or software components of the UE 106 may be configured for detecting radio frequency conditions and radio link failures.

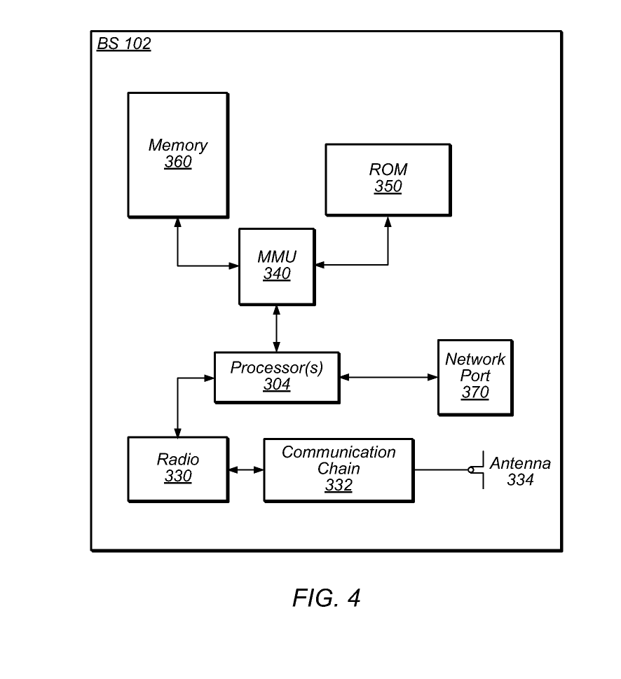

FIG. 4 illustrates a block diagram of an embodiment of a base station. It is noted that the base station of FIG. 4 is merely one example of a possible base station. As shown, the base station 102 may include processor(s) 304 which may execute program instructions for the base station 102. The processor(s) 102 may also be coupled to memory management unit (MMU) 340, which may be configured to receive addresses from the processor(s) 102 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIGS. 1A and 1B.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

The base station 102 may include at least one antenna 334. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless telecommunication standards, including, but not limited to, LTE, CDMA, etc.

The processor 304 of the base station 102 may be configured to implement part or all of the methods described herein, e.g., by executing program instructions stored on a memory medium (e.g., a non-transitory computer-readable memory medium). Alternatively, the processor 304 may be configured as a programmable hardware element, such as an FPGA (Field Programmable Gate Array), or as an ASIC (Application Specific Integrated Circuit), or a combination thereof.

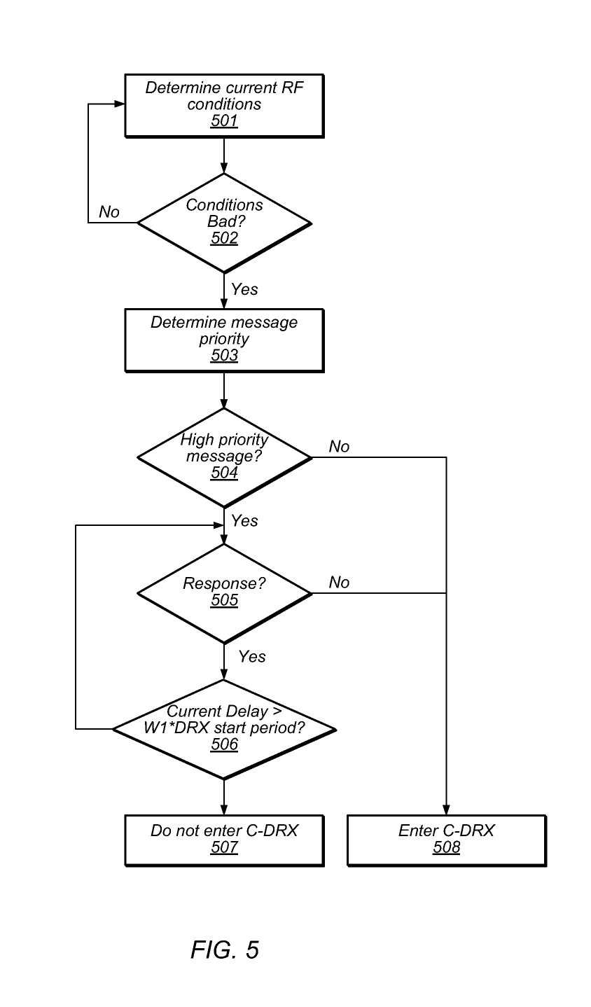

Turning to FIG. 5 a flow chart depicting an example method operating a UE is illustrated. The method begins in block 501 with the UE automatically determining the conditions of RF signal it is currently receiving. The determination may be made counting the number of received data packets, or in some embodiments, the UE may measure the RTT of a message and compare the measured RTT against a pre-determined threshold value. The operation then depends on the state of the RF conditions (block 502). When the RF conditions are not bad, the UE continues to check to the RF conditions (block 501).

When the RF conditions are bad, such as when the UE is moving away from a BS, the priority of outgoing messages may be examined (block 503). In some embodiments, messages such as a measurement report are of higher priority to the proper operation of the UE in the network than other messages such as, e.g., data packets. The method then depends on the determined priority of the message (block 504). When a message that does not have high priority is detected, the UE may enter C-DRX mode (block 508).

When a high priority message is detected, the UE may then waits for a response to the message (block 505). The operation then depends on the whether or not a response is received. When a response is not received, the UE may enter C-DRX mode (block 508) and the method concludes. When a response is received, the method then depends on value of the current delay in receiving a response (block 506). When the current delay is less than or equal to a threshold value, the UE may continue to monitor the response time for high priority messages (block 505). When the current delay is greater than the threshold value, the UE does not enter C-DRX mode (block 507). In some embodiments, the threshold value may be dependent upon the specified DRX start period as defined in the 3GPP standards. In other embodiments, a weight factor may be applied to the specified DRX start period to determine the threshold value.

It is noted that the operations illustrated in the method depicted in FIG. 5 are shown as being executed sequentially. In other embodiments, some or all of the illustrated operations may be performed in parallel or in a different order than what is depicted in FIG. 5.

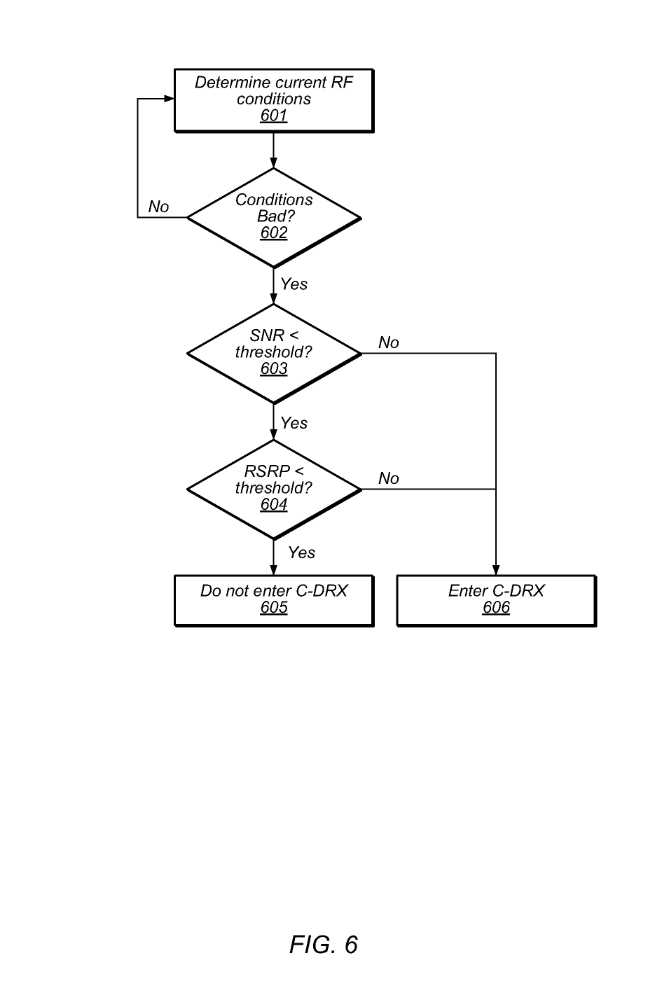

An alternative embodiment of a method of operating a UE connected to a network is illustrated in FIG. 6. The method begins, as described in more detail above in reference to FIG. 5, with the UE detecting the RF conditions (block 601). The operation then depends on the detected RF conditions (block 602). When the RF conditions are acceptable, the UE continues to detect the RF conditions (block 601).

When the RF conditions are not good, the signal-to-noise ratio (SNR) of the signal being received by the UE is checked against a pre-determined threshold (block 603). When the SNR is greater than the pre-determined threshold, the UE enters C-DRX mode (block 606). When the SNR is less than or equal to the pre-determined threshold, the reference signal received power (RSRP) is checked against another pre-determined threshold (block 604). When the RSRP is greater than the pre-determined threshold, the UE enters C-DRX mode (block 606). When the RSRP is less than or equal to the pre-determined threshold, the UE does not enter C-DRX mode (block 605). In some embodiments, the pre-determined threshold values for the SNR and RSRP checks may be dependent upon a characterization of the network.

It is noted that the flowchart illustrated in FIG. 6 is merely an example. In other embodiments, different operations and different order of operations are possible and contemplated.

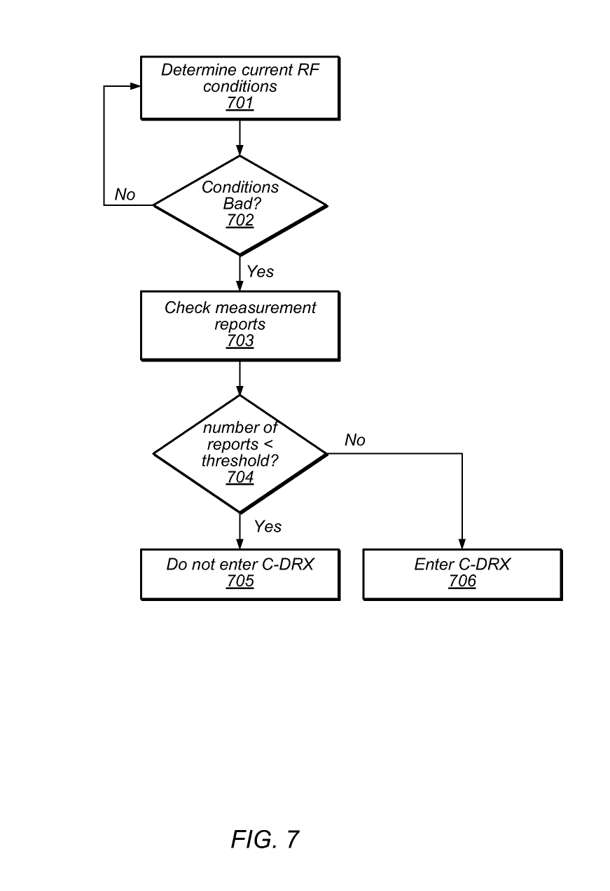

Turning to FIG. 7, an embodiment of a method for operating a UE connected to a network is illustrated. The method begins with the UE checking current RF conditions as described in more detail in reference to FIG. 5 (block 701). The method then depends on the results of the check of RF conditions (block 702). When the RF conditions are acceptable, the UE continues to check the conditions (block 701).

When the RF conditions are not good, the UE may then check the number of measurement reports (block 703). In some embodiments, a measurement report may include intra-frequency measurement results, inter-frequency measurement results, and the like. The method then depends on the number of measurement reports (block 704).

When the number of measurement reports is greater than a pre-determined threshold value, the UE may enter C-DRX mode (block 706). When the number of measurement reports is less than or equal to the pre-determined threshold, the UE may not enter C-DRX mode (block 705). It is noted that in method of operating a UE illustrated in FIG. 7 is merely an example. In other embodiments, additional operations may be employed, and the execution order of the various operations may be different.

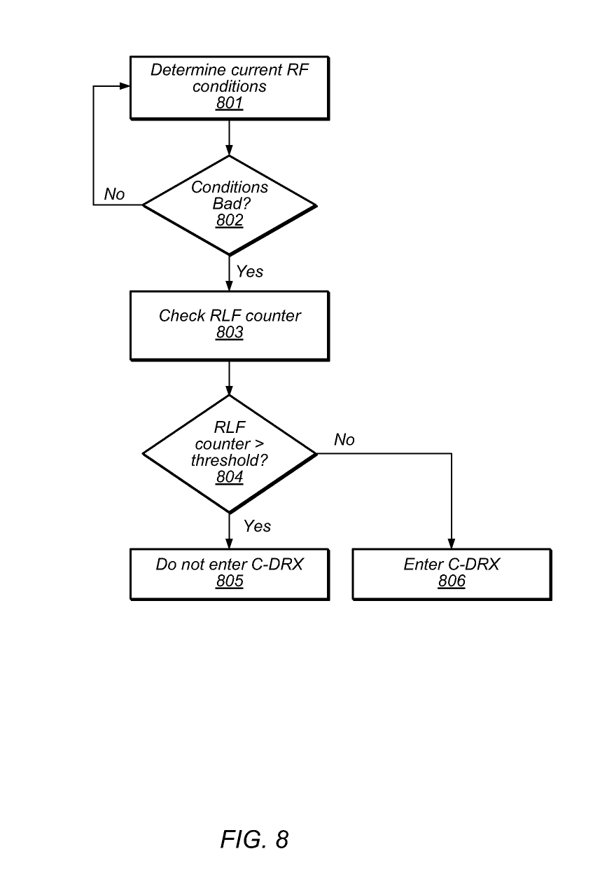

Another embodiment of a method of operating a UE connected to a network is illustrated in FIG. 8. As described above in more detail with reference to FIG. 5, the method begins with the UE detecting its current RF conditions (block 801). The operation is then dependent on the result of the RF condition check (block 802). When the RF conditions are not bad, the RF condition check continues (block 801).

When the RF conditions are poor, the UE checks the status of the radio link failure (RLF) counter (block 803). The operation is then dependent upon the result of the value currently stored in the RLF counter (block 804). When the value currently stored in the RLF counter is greater than a pre-determined threshold value, the UE enters C-DRX mode (block 806).

When the currently stored value in the RLF counter is less than or equal to the pre-determined threshold, the UE does not enter C-DRX mode (block 805). In some embodiments, the value stored in the RLF counter may be incremented dependent upon successive receipt of “out of sync” messages.

The method illustrated in FIG. 8 is merely an example. In other embodiments, additional operations, and different order or operations may be possible.

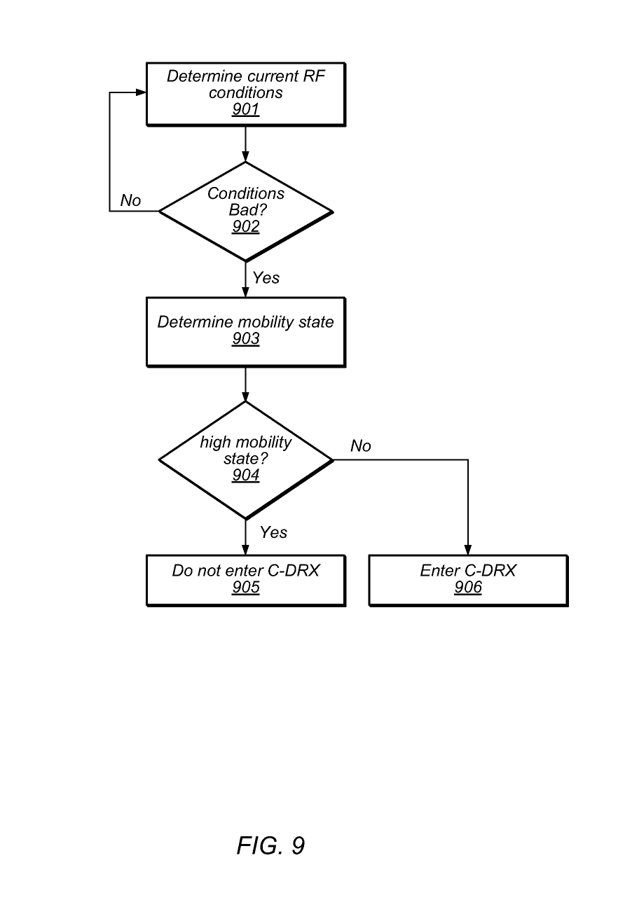

Turning to FIG. 9, an embodiment of a method of operating a UE connected to a network is illustrated. In block 901, the UE determines the current RF conditions as described in more detail above in reference to FIG. 5. The operation then depends on the determined RF conditions (block 902). When the current RF conditions are acceptable, the monitoring of RF conditions continues (block 901).

When the current RF conditions are poor, the mobility state is determined (block 903). In some embodiments, the mobility states may include states such as, e.g., detached, idle, or active, while in other embodiments, the mobility state may include a measure of how quickly the RF conditions are degrading. The operation then depends on the determined mobility state (block 904).

When the mobility state is determined to not be high, the UE may enter C-DRX mode (block 906). When the mobility state is determined to be high, the UE may not enter C-DRX mode (block 905). It is noted that in the method illustrated in FIG. 9, the operations are depicted as occurring in a sequential fashion. In other embodiments, some or all of the operations may occur in parallel or in a different order than illustrated in FIG. 9.

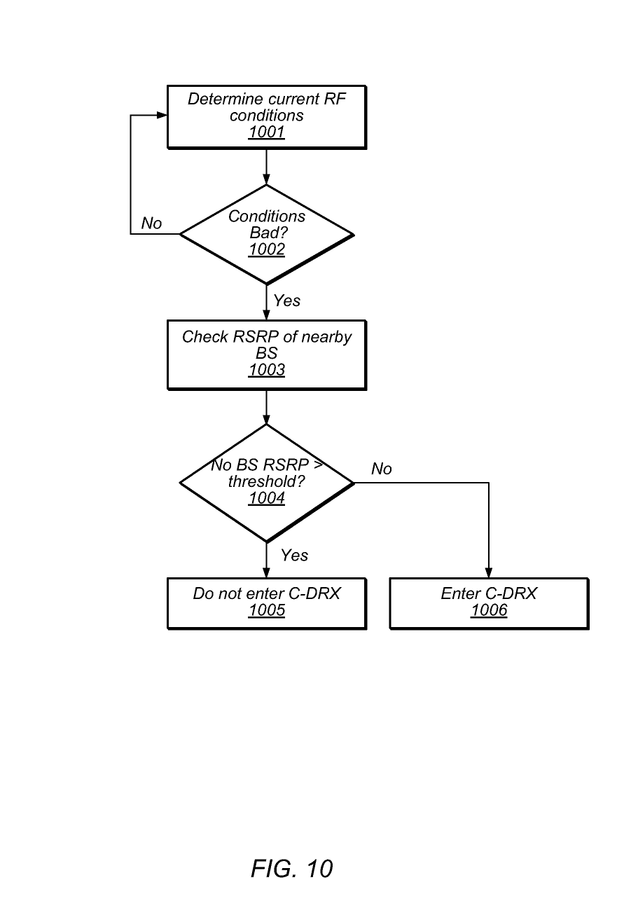

An alternative embodiment of a method of operating a UE connected to a network is illustrated in FIG. 10. In the illustrated embodiment, the method begins with the UE checking current RF conditions as described above in more detail in reference to FIG. 5 (block 1001). The method then depends on the determined RF conditions (block 102). When the RF conditions are acceptable, the UE continues to check the current RF conditions (block 1001).

When the current RF conditions are degrading, the signal strength to nearby base stations may be checked (block 1003). In some embodiments, the RSRP of a base station may be compared against a pre-determined threshold value to determine signal strength. The method is then dependent on the number of base stations with signal strength above a pre-determined threshold (block 1004). When at least one base station has a signal strength above the pre-determined threshold value, then the UE enters C-DRX mode (block 1006). When no nearby base stations have a signal strength above the pre-determined threshold value, the UE does not enter C-DRX mode (block 1005).

It is noted that the method illustrated in FIG. 10 is merely an example. In other embodiments, different operations may be included in the method, and other operations may be omitted.

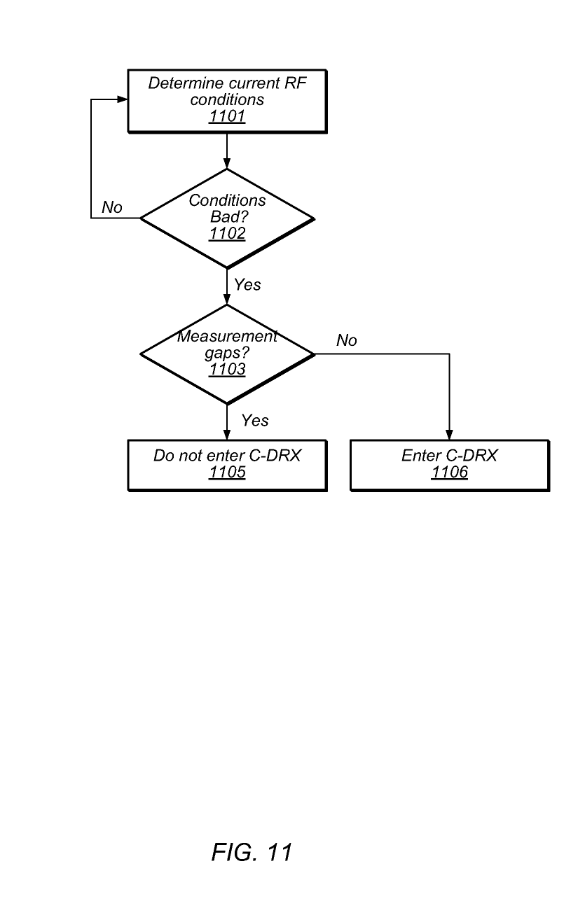

Turning to FIG. 11, an embodiment of a method for operating a UE connected to a network is illustrated. As described above in more detail in reference to FIG. 5, the operation begins with the UE checking current RF conditions (block 1101). The method is then dependent upon the result of the RF condition check (block 1102). When the RF conditions are acceptable, the UE continues to check the RF conditions (block 1101).

The method then depends on whether or not measurement gaps have been enabled (block 1103). In some embodiments, measurement gaps may be enabled to provide a period of time when the UE is not sending or receiving data from the network in order to allow it a period of time to try alternative channels or frequencies searching for a better connection to the network.

When measurement gaps are not enabled, the UE enters C-DRX mode (block 1105). When measurement gaps are enabled, the UE may not enter C-DRX mode (block 1104). It is noted that the method illustrated in FIG. 11 is merely an example. In other embodiments, different operations and different orders of operations are possible and contemplated.

Although the embodiments above have been described in considerable detail, numerous variations and modifications will become apparent to those skilled in the art once the above disclosure is fully appreciated. It is intended that the following claims be interpreted to embrace all such variations and modifications.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Numerous variations and modifications will become apparent to those skilled in the art once the above disclosure is fully appreciated. It is intended that the following claims be interpreted to embrace all such variations and modifications.

What is claimed is:

1. A wireless user equipment (UE) device configured to wirelessly communicate with a cellular network, comprising:
a radio including one or more antennas for performing wireless communication;
a processing element, wherein the processing element is configured to:
detect radio frequency (RF) conditions;
determine the priority of a transmitted message in response the detection of the RF conditions;
activate connected mode discontinuous reception (C-DRX) dependent upon the determined priority.

2. The UE of claim 1, wherein the processing element is further configured to measure the response time of the transmitted message.

3. The UE of claim 2, wherein the processing element is further configured to compare the measured response time against a predetermined delay.

4. The UE of claim 1, wherein the processing element is further configured to not activate C-DRX mode in response to the determination that the transmitted message priority is high.

5. The UE of claim 1, wherein the processing element is further configured to activate C-DRX mode in response to the determination that the transmitted message priority is low.

6. The UE of claim 1, wherein to detect RF conditions, the processing element is further configured to determine a number of received data packets.

7. A computer-readable non-transitory storage medium, having program instructions stored therein, that in response to executing by a wireless user equipment (UE) device connected to a network, cause the UE to perform operations comprising:
detecting radio frequency (RF) conditions;
determining signal strength dependent upon the detected RF conditions;
activating a low power mode dependent upon the determined signal strength.

8. The computer-readable non-transitory storage medium of claim 7, wherein detecting RF conditions comprises determining a number of received data packets.

9. The computer-readable non-transitory storage medium of claim 7, wherein detecting RF conditions comprises determining round trip time (RTT) of messages.

10. The computer-readable non-transitory storage medium of claim 7, wherein determining signal strength comprises comparing a signal to noise ration (SNR) to a pre-determined SNR threshold.

11. The computer-readable non-transitory storage medium of claim 8, wherein determining signal strength further comprises comparing the reference signal received power (RSRP) to a pre-determined RSRP threshold.

12. The computer-readable non-transitory storage medium of claim 7, wherein the low power mode comprises a connected mode discontinuous reception (C-DRX).

13. The computer-readable non-transitory storage medium of claim 10, wherein the operations further comprises characterizing the network.

14. The computer-readable non-transitory storage medium of claim 13, wherein the predetermined SNR threshold is dependent upon the characterized network.

15. A method for operating a wireless user equipment (UE) device, the method comprising:
detecting radio frequency (RF) conditions;
determining a number of radio link failures (RLFs) dependent upon the detected radio frequency conditions;
activating a low power mode dependent upon the determined number of RLFs.

16. The method of claim 15, wherein the low power mode comprises a connected mode discontinuous reception (C-DRX).

17. The method of claim 15, wherein detecting RF conditions comprises measuring round trip time (RTT) messages.

18. The method of claim 15, wherein activating the low power mode comprises comparing the determined number of RLFs to a pre-determined threshold value.

19. The method of claim 18, wherein determining the number of RLFs comprises incrementing a counter.

20. The method of claim 15, wherein detecting RF conditions comprises determining a number of received data packets.
